(19) United States
(12) Patent Application Publication
(10) Pub. No.: US 2010/0250665 A1
(43) Pub. Date: Sep. 30, 2010

(54) CONTENT DISTRIBUTION SYSTEM, TERMINAL APPARATUS, CONTENT DISTRIBUTION APPARATUS, ADDITIONAL INFORMATION DISTRIBUTION APPARATUS, CONTENT RECORDING METHOD, AND RECORDING MEDIUM

(76) Inventors: Ryuichi Okamoto, Osaka (JP); Koji Miura, Osaka (JP); Satoshi Niwano, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/745,756

(22) PCT Filed: Oct. 2, 2009
(86) PCT No.: PCT/JP2009/005099

§ 371 Date: Jun. 2, 2010

(30) Foreign Application Priority Data
Oct. 3, 2008 (JP) 2008-258146

(51) Int. Cl. G06F 15/16

(52) U.S. Cl. 709/203

(57) ABSTRACT

Provided is a content distribution system and the like that enables division at an appropriate position when dividing a content to record the content on a recording medium. A content distribution system (100) includes: a content distribution apparatus (200) that distributes a content; and a terminal apparatus (300) that records the content. The content distribution apparatus (200) includes: a storage unit (201) that stores division information indicating a division position at which the content is divided; and a distribution unit (204) that reads the division information from the storage unit (201) and distributes the division information to the terminal apparatus (300). The terminal apparatus (300) includes: a receiving unit (302) that receives the division information from the content distribution apparatus (200); and a recording unit (304) that obtains the content divided at the division position indicated by the division information and records divisional contents on plural recording medium (304).

### TECHNICAL FIELD

The present invention relates to a content distribution system that enables a user to use a digital content on a terminal apparatus by distributing the digital content such as an image and music from a content distribution apparatus such as a server to the terminal apparatus by using a network. The present invention further relates to a terminal apparatus, a content distribution apparatus, an additional information distribution apparatus, a content recording method, and a recording medium, concerning the content distribution system.

### BACKGROUND ART

In recent years, a system called a content distribution system has moved into a practical phase which enables: distribution of a digital content such as music, images, games, and so on (hereinafter referred to as a “content”) via digital broadcasting or communication such as the Internet, from a server to a terminal device; and use of the content on the terminal apparatus.

In the content distribution system, information that is necessary for using a content and includes a usage rule for the content, a content key, and the like (hereinafter referred to as a “license”) is distributed, and a terminal apparatus in a home reproduces the content, records the content on a recording medium, and so on, using the license distributed from the server. A recording destination of a content includes a mixed variety of recording media with different recording capacities such as a blu-ray disc (BD) and a digital versatile disc (DVD).

A known conventional technique as described above (hereinafter referred to as “the first conventional technique”) includes a media information distribution system in which a center apparatus distributes media information via a communications line in response to a distribution request of the media information from a terminal apparatus, and the terminal apparatus records the distributed media information on a recording medium (see Patent Literature 1, for example).

Another known conventional technique (hereinafter referred to as “the second conventional technique”) includes a broadcasting apparatus which broadcasts chapter instruction data that gives instruction to perform chapter division at an intended position on the time axis of a contest to be broadcast, by attaching the chapter instruction data to the content (see Patent Literature 2, for example).

### CITATION LIST

### Patent Literature

### [PTL 1] Japanese Unexamined Patent Application Publication No. 07-297949

### [PTL 2] Japanese Unexamined Patent Application Publication No. 2006-148839

### SUMMARY OF INVENTION

### Technical Problem

In the case where a content intended to be recorded on a recording medium with a large recording capacity such as a BD is recorded on a recording medium with a smaller recording capacity such as a DVD, the content needs to be divided to be recorded on plural recording media.

In such a case, however, there is a problem that the position at which the content is divided is not necessarily appropriate for the creator or the provider of the content. For example, there is a possibility that a movie content may be divided in the middle of a series of scenes. In addition, there also is a possibility that the position at which a content is divided by a user is different from the intended position of a content creator.

In such cases, use of the second conventional technique allows a content creator to specify the position to divide the content with a chapter position.

However, even when a content is divided at the chapter position, the volume of a divisional content may still be large. A content intended for high definition (HD) broadcasting and the like or for three-dimensional images apply to such a case, for example. In such a case, recording the divisional content on a recording medium with an insufficient capacity such as a DVD necessitates further division for recording as the volume of the content on which chapter division has been performed exceeds the capacity of the recording medium as described above, which leaves a problem that the position at which the content is divided is not appropriate for a content creator or a content provider.

The present invention presents a solution to the above-stated problems and aims to provide a content distribution system and the like that enables division at an appropriate position when dividing a content to record the content on a recording medium.

### Solution to Problem

In order to solve the above-described problem, a content distribution system according to an implementation of the present invention is a content distribution system that includes: a content distribution apparatus that distributes a content; and a terminal apparatus that records the content. The content distribution apparatus includes: a storage unit that stores division information used for dividing and recording the content on plural recording media; a distribution request receiving unit that receives a distribution request for the division information from the terminal apparatus; a reading unit that reads the division information from the storage unit; and a distribution unit that distributes the division information to the terminal apparatus. The terminal apparatus includes: a distribution requesting unit that requests the content distribution apparatus for distribution of the division information; a receiving unit that receives the division information from the content distribution apparatus; a determining unit that determines, based on the division information, whether to record the content on a single recording medium or to divide and record the content on plural recording media; and a recording unit that obtains divisional contents generated by dividing the content based on the division information and records the divisional contents on the plural recording media in the case where the determining unit determines to record the content on plural recording media.

### ADVANTAGEOUS EFFECTS OF INVENTION

According to the present invention, it is possible, when a content is divided and recorded on plural recording media, to divide the content at an appropriate position intended by a content creator or a content provider.

### BRIEF DESCRIPTION OF DRAWINGS

FIG. 1 is a diagram which shows an overall configuration of a content distribution system according to Embodiment 1 of the present invention.

FIG. 2 is a diagram which shows an example of a content file stored by a content distribution apparatus according to Embodiment 1 of the present invention.

FIG. 3 is a diagram which schematically shows an example of recording instruction information stored by the content distribution apparatus according to Embodiment 1 of the present invention.

FIG. 4 is a diagram which schematically shows processing of generating divisional contents in the content distribution system according to Embodiment 1 of the present invention.

FIG. 5 is a flow chart which shows processing of content recording method in the content distribution system according to Embodiment 1 of the present invention.

FIG. 6 is a flow chart which shows a processing operation from determining a content to a recording in the content distribution system according to Embodiment 1 of the present invention.

FIG. 7 is a diagram which schematically shows an example of information presented by a user interaction unit of a terminal apparatus in the determining the content in the content distribution system according to Embodiment 1 of the present invention.

FIG. 8 is a diagram which shows an overall configuration of a content distribution system according to Embodiment 2 of the present invention.

FIG. 9 is a diagram which shows an example of recording instruction information stored by the content distribution apparatus according to Embodiment 2 of the present invention.

FIG. 10 is a diagram which schematically shows processing of generating divisional contents in the content distribution system according to Embodiment 2 of the present invention.

FIG. 11 is a diagram which shows an overall configuration of a content distribution system according to Embodiment 3 of the present invention.

FIG. 12 is a diagram which shows an example of recording instruction information stored by the content distribution apparatus according to Embodiment 3 of the present invention.

FIG. 13 is a diagram which schematically shows processing of generating divisional contents in the content distribution system according to Embodiment 3 of the present invention.

FIG. 14 is a flow chart which shows processing of content recording method in the content distribution system according to Embodiment 3 of the present invention.

FIG. 15 is a flow chart which shows a part of a modification example of processing of content recording method in the content distribution system according to Embodiment 3 of the present invention.

### DESCRIPTION OF EMBODIMENTS

An implementation of the content distribution system according to the present invention is a content distribution system including: a content distribution apparatus configured to distribute a content; and a terminal apparatus configured to record the content, wherein the content distribution apparatus includes: a storage unit configured to store division information indicating a division position at which the content is divided; and a distribution unit configured to distribute, to the terminal apparatus, the division information read from the storage unit, and the terminal apparatus includes: a receiving unit configured to receive the division information from the content distribution apparatus; and a recording unit configured to record each of divisional contents on a corresponding one of recording media, the divisional contents being generated by dividing the content at the division position indicated by the division information.

According to the above configuration, since the content distribution apparatus distributes, to the terminal apparatus, division information indicating a position at which a content is divided, even when the content is divided due to a small capacity of the recording medium, the terminal apparatus can record, on plural recording media, the content divided at an appropriate position intended by a content provider.

Further, it is preferable that: in the content distribution apparatus, the storage unit is further configured to store additional information to be added to the divisional contents, and the distribution unit is further configured to distribute, to the terminal apparatus, the additional information read from the storage unit; and in the terminal apparatus, the receiving unit is further configured to receive the additional information from the content distribution apparatus, and the recording unit is further configured to record the additional information together with each of the divisional contents on a corresponding one of the recording media.

According to the above configuration, since the content distribution apparatus distributes the additional information to be added to the divisional contents, it is possible to add the additional information to the divisional contents. Thus, the content provider can divide the content at an intended position, and can add additional information such as credit information to the divisional contents.

Further, it is preferable that: the content distribution system includes an additional information distribution apparatus configured to manage additional information to be added to the divisional contents, the additional information distribution apparatus including an additional information storing unit configured to store the additional information, and an additional information distribution unit configured to distribute, to the terminal apparatus, the additional information read from the additional information storing unit; in the content distribution apparatus, the storage unit is further configured to store additional-information-source information indicating a source from which the additional information is obtained, and the distribution unit is further configured to distribute the additional-information-source information to the terminal apparatus; and in the terminal apparatus, the receiving unit is further configured to receive the additional-information-source information from the content distribution apparatus and to receive the additional information from the additional information distribution apparatus based on the additional-information-source information, and the recording unit is further configured to record the additional information together with each of the divisional contents on a corresponding one of the recording media.

According to the above configuration, since the additional information distribution apparatus can distribute additional information of the content when necessary, the load of distributing the additional information is eliminated from the content distribution apparatus.

Further, it is preferable that the recording unit is configured to add the additional information before or after each of the divisional contents.

According to the above configuration, since the additional information can be added to a predetermined position of the divisional contents, it is possible to insert the additional information into a position intended by a content provider.

Further, it is preferable that the terminal apparatus includes a divisional content generating unit configured to generate the divisional contents by dividing the content.

According to the above configuration, since the divisional contents can be generated in the terminal apparatus, the user of the terminal apparatus can divide a content as desired according to the type of the recording medium.

Further, it is preferable that the recording media are removably mounted on the terminal apparatus.

According to the above configuration, since the recording medium is removable from the terminal apparatus, it is possible for the user of the terminal apparatus to record the divisional contents on the recording medium by selecting a recording medium at will.

Further, an implementation of the terminal apparatus according to the present invention is a terminal apparatus which obtains a content and records the content on at least one of recording media, the terminal apparatus including: a receiving unit configured to receive division information from a content distribution apparatus that stores the division information indicating a position at which the content is divided; and a recording unit configured to record each of divisional contents on a corresponding one of the recording media, the divisional contents being generated by dividing the content at the division position indicated by the division information.

According to the above configuration, since the terminal apparatus, even when a content is to be divided due to a small capacity of the recording medium, can divide the content based on the division information distributed from the content distribution apparatus and record the content that has been divided on recording media, it is possible to divide the content at a position intended by a content provider.

Further, it is preferable that the content distribution apparatus stores additional information to be added to the divisional contents, the receiving unit is further configured to receive the additional information from the content distribution apparatus, and the recording unit is further configured to record the additional information together with each of the divisional contents on the corresponding one of the recording media.

According to the above configuration, since the content distribution apparatus distributes the additional information to be added to the divisional contents, it is possible to add the additional information to the divisional contents. Thus, the content provider can divide the content at an intended position, and can add additional information such as credit information to the divisional contents.

Further, it is preferable that: the terminal apparatus is connected to an additional information distribution apparatus that manages the additional information to be added to the divisional contents; the content distribution apparatus further stores additional-information-source information indicating a source from which the additional information is obtained; in the terminal apparatus, the receiving unit is further configured to receive the additional-information-source information from the content distribution apparatus and to receive the additional information from the additional information distribution apparatus based on the additional-information-source information; and the recording unit is further configured to record the additional information together with each of the divisional contents on the corresponding one of the recording media.

According to the above configuration, since the additional information distribution apparatus can distribute additional information of the content when necessary, the load of distributing the additional information is eliminated from the content distribution apparatus.

Further, it is preferable that the recording unit is configured to add the additional information before or after each of the divisional contents.

According to the above configuration, since the additional information can be added to a predetermined position of the divisional contents, it is possible to insert the additional information into a position intended by a content provider.

Further, it is preferable that the terminal apparatus further includes a divisional content generating unit configured to generate the divisional contents by dividing the content.

According to the above configuration, since the divisional contents can be generated in the terminal apparatus, the user of the terminal apparatus can divide a content as desired according to the type of the recording medium.

Further, it is preferable that the recording media are removably mounted on the terminal apparatus.

According to the above configuration, since the recording medium is removable from the terminal apparatus, it is possible for the user of the terminal apparatus to record the divisional contents on the recording medium by selecting a recording medium at will.

Further, it is preferable that the terminal apparatus further includes: a detecting unit configured to detect a type of the recording media; and a determining unit configured to determine, based on the division information and the type of each of the recording media detected by the detecting unit, whether the content is to be recorded on a single recording medium among the recording media or to be divided and recorded on the recording media.

According to the above configuration, since the type of the recording medium can be detected, it is possible to select a recording medium according to the volume of a content and to prepare a necessary number of recording media.

Further, it is preferable that the determining unit is configured to record the content on the recording medium without dividing the content in the case where it is determined that the content need not be divided.

Since the above configuration eliminates the need to divide a content when it is unnecessary to divide the content, it is possible to determine whether or not to divide the content for recording according to the type of recording media, thereby allowing an appropriate recording suitable to each of the recording media of plural types with different recording capacities.

Further, an implementation of the content distribution system according to the present invention is a content distribution apparatus which distributes a content to a terminal apparatus that records divisional contents on recording media, the content distribution apparatus including: a storage unit configured to store division information indicating a division position at which the content is divided; and a distribution unit configured to distribute, to the terminal apparatus, the division information read from the storage unit.

According to the above configuration, since the content distribution apparatus distributes, to the terminal apparatus, division information indicating a position at which a content is divided even when the content is divided due to a small capacity of the recording medium, it is possible to divide the content at a position intended by a content provider.

Further, it is preferable that the storage unit is further configured to store additional information to be added to the content divided based on the division information, and the distribution unit is further configured to distribute, to the terminal apparatus, the additional information read from the storage unit.

According to the above configuration, since the content distribution apparatus distributes the additional information to be added to the divisional contents, it is possible to add the additional information to the divisional contents. Thus, the content provider can divide the content at an intended position, and can add additional information such as credit information to the divisional contents.

Further, an implementation of an additional information distribution apparatus according to the present invention is an additional information distribution apparatus which distributes, to a terminal apparatus that divides and records a content on recording media, additional information to be added to divisional content, the additional information distribution apparatus being connected to a content distribution apparatus that distributes, to the terminal apparatus, division information indicating a position at which the content is divided and additional-information-source information indicating a source from which the additional information is obtained, the additional information distribution apparatus including: an additional information storing unit configured to store the additional information; and an additional information distribution unit configured to distribute, to the terminal apparatus, the additional information read from the additional information storing unit.

According to the above configuration, since additional information to be added to the divisional contents can be distributed from a distribution apparatus different from the content distribution apparatus, it is possible to eliminate the load of distributing the additional information from the content distribution apparatus.

Further, an implementation of a content recording method according to the present invention is a content recording method for recording a content distributed from a content distribution apparatus by using a terminal apparatus, the method including: distributing division information from the content distribution apparatus to the terminal apparatus, the division information indicating a division position at which the content is divided; and recording each of divisional contents on a corresponding one of recording media, the divisional contents being generated by dividing the content at the division position indicated by the division information.

Further, an implementation of a computer-readable recording medium according to the present invention is a computer-readable recording medium on which a program for recording, using a terminal apparatus, a content distributed from a content distribution apparatus is stored, the program allowing a computer to execute: distributing division information from the content distribution apparatus to the terminal apparatus, the division information indicating a division position at which the content is divided; and recording each of divisional contents on a corresponding one of recording media, the divisional contents being generated by dividing the content at the division position indicated by the division information.

According to the above configuration, since the content distribution apparatus distributes, to the terminal apparatus, the division information indicating a position at which a content is divided, it is possible to divide the content at a position intended by a content provider.

Further, it is preferable that, in the content recording method or the computer-readable recording medium, obtaining additional information to be added to the divisional contents is included, and the recording includes recording the additional information together with each of the divisional contents on the corresponding one of the recording media.

According to the above configuration, since the content distribution apparatus distributes the additional information to be added to the divisional contents according to the above configuration, it is possible to add the additional information to the divisional contents. Thus, the content provider can divide the content at an intended position, and can add additional information such as credit information to the divisional contents.

The following describes embodiments according to the present invention in detail with reference to the drawings.

### Embodiment 1

First, a content distribution system according to Embodiment 1 of the present invention is described.

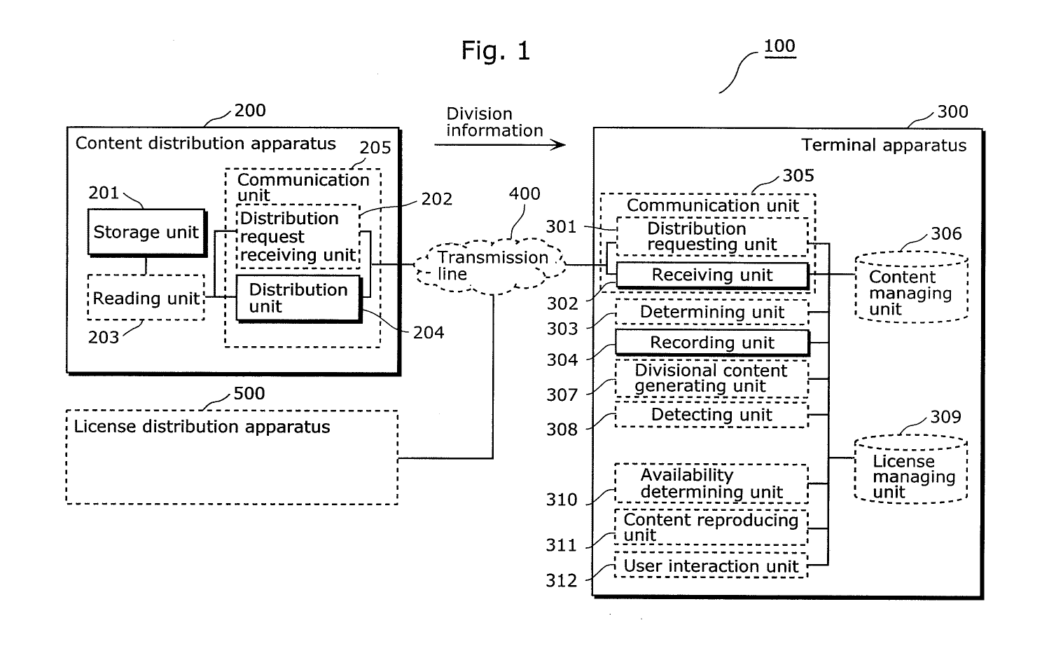

FIG. 1 is a diagram which shows an overall configuration of the content distribution system according to Embodiment 1 of the present invention.

A content distribution system 100 according to Embodiment 1 of the present invention is a system that distributes division information indicating a position at which a content is divided, from a content distribution apparatus to a terminal apparatus, and includes a content distribution apparatus 200 and a terminal apparatus 300, as shown in FIG. 1. The content distribution apparatus 200 and the terminal apparatus 300 are connected to each other via a transmission line 400. Further, the terminal apparatus 300 may be connected to a license distribution apparatus 500 via the transmission line 400, as shown in FIG. 1.

The following describes each of the components in the content distribution system.

The content distribution apparatus 200 according to the present embodiment is an apparatus that distributes a content and division information indicating a position at which the content is divided, and the example thereof includes a content server, for example. The content distribution apparatus 200 according to the present embodiment is an apparatus that distributes a content and division information to the terminal apparatus 300 in response to a request from the terminal apparatus 300.

As shown in FIG. 1, the content distribution apparatus 200 according to Embodiment 1 of the present invention includes: a storage unit 201; a distribution request receiving unit 202; a reading unit 203; and a distribution unit 204.

The storage unit 201 is a hard disk which stores a content and division information used for dividing the content. Here, a content refers to a digital content such as an image in movies and the like, music, games and so on, and also refers directly to content data in some cases. In the present embodiment, “content” hereinafter represents content data unless a particular description is provided. Further, division information indicates a position at which a content is divided when recording the content on a recording medium, and the like. The position at which a content is divided is determined according to the type of a recording medium.

The distribution request receiving unit 202 is a processing unit that receives a request, from the terminal apparatus 300, for distributing the division information. Further, the distribution request receiving unit 202 also receives a request, from the terminal apparatus 300, for distributing the content.

The reading unit 203, which is a control circuit and the like that reads the division information from the storage unit 201, reads the division information stored by the storage unit 201 when the distribution request receiving unit 202 receives the request for distributing the division information. Further, the reading unit 203 also reads the content from the storage unit 201 in the case where a request, from the terminal apparatus 300, for distributing the content is received. The division information and the content which have been read from the storage unit 201 are transmitted as data to the distribution unit 204.

The distribution unit 204, which is a processing unit that distributes the division information to the terminal apparatus 300, distributes the division information read by the reading unit 203, in response to the request, from the terminal apparatus 300, for distributing the division information. Further, the distribution unit 204 also distributes the content to the terminal apparatus 300 in the case where the request, from the terminal apparatus 300, for distributing the content is received.

It is to be noted that, the communication unit 205, which includes the distribution request receiving unit 202 and the distribution unit 204, is a communication interface that performs communication with the outside such as the terminal apparatus 300 via the transmission line 400.

The following describes the terminal apparatus 300. The terminal apparatus 300 is an apparatus that receives a content or division information from the content distribution apparatus 200 and records the content on a recording medium. The terminal apparatus 300 is, for example, a personal computer (PC), a BD recorder, and the like.

As shown in FIG. 1, the terminal apparatus 300 according to Embodiment 1 of the present invention includes: a distribution requesting unit 301; a receiving unit 302; a determining unit 303; a recording unit 304; a communication unit 305 including the distribution requesting unit 301 and the receiving unit 302; a content managing unit 306; a divisional content generating unit 307; a detecting unit 308; a license managing unit 309; an availability determining unit 310; a content reproducing unit 311; and a user interaction unit 312. The following describes a configuration of each of the above-described components.

The distribution requesting unit 301 is a control circuit and the like that requests the content distribution apparatus 200 to distribute division information to the terminal apparatus 300. Further, the distribution requesting unit 301 also requests the content distribution apparatus 200 for distributing a content.

The receiving unit 302 receives the division information from the content distribution apparatus 200. Further, the receiving unit 302 also receives the content from the content distribution apparatus 200. Further, the receiving unit 302 also receives a license from the license distribution apparatus 500.

The determining unit 303 is a control circuit and the like that determines whether to record the content on a single recording medium or to divide the content to be recorded on plural recording media, based on the division information that has been received.

The recording unit 304 is a control circuit and the like that obtains the content distributed from the content distribution apparatus 200 or a content divided into plural pieces at a position to divide the content indicated by the division information (hereinafter referred to as a divisional content) and records the content or the divisional content on a recording medium such as a DVD. The recording unit 304, in the case where the determining unit 303 determines that the content is to be recorded on plural recording media, records the divisional content divided into plural pieces based on the division information, on recording media of the number corresponding to the number of division. Further, the recording unit 304 records the content on a single recording medium in the case where the determining unit 303 determines that it is not necessary to divide the content.

The communication unit 305 is a communication interface that performs communication with the terminal apparatus 300 or the license distribution apparatus 500 via the transmission line 400.

The content managing unit 306 is a hard disk and the like that accumulates the content received by the receiving unit 302. It is to be noted that, information received from the content distribution apparatus 200 may be metadata, recording instruction information including division information, and the like, in addition to content (content data), or a content file including the information described above. The content managing unit 306 accumulates the content (content data), the metadata and the recording instruction information, or the content file including the above.

The divisional content generating unit 307 is a control circuit and the like which divides the content (content data) according to the division information received from the content distribution apparatus 200 and generates divisional contents to be recoded on plural recording media.

The detecting unit 308 is a control circuit and the like which detects the type of the recording medium removably mounted on the terminal apparatus and a recording system for recording on the recording medium.

The license managing unit 309 is a hard disk and the like that accumulates and manages the license obtained by the receiving unit 302.

The availability determining unit 310 is a program and the like that determines the availability of the content data. The availability determining unit 310 determines that the content data can be used in the case where a license corresponding to the content that is the object of determining the availability is accumulated in the license managing unit 309 and a usage rule included in the license is satisfied.

The content reproducing unit 311 is a decoder or an AV player that reproduces the content obtained from the content distribution apparatus 200 and accumulated in the content managing unit 306, or the content that has been divided. Further, the content reproducing unit 311 reproduces the content or the divisional contents recorded on the recording medium removably mounted on the terminal apparatus 300.

The user interaction unit 312 interacts with a user of the terminal apparatus 300. To be specific, the user interaction unit 312 is a display unit that presents or displays various information to the user (a display, for example), or a receiving unit that receives various instructions from the user (a keyboard, for example).

In addition, each of the components described above is connected to each other with a common bus (not illustrated) and also connected to a control unit for implementing each function (not illustrated).

The following described the transmission line 400. The transmission line 400, which includes a wire transmission medium, a wireless transmission medium, and a portable recording medium, such as the Internet, cable television (CATV), and broadcast wave, connects the content distribution apparatus 200, the terminal apparatus 300, and the license distribution apparatus 500 to be able to exchange data among each other.

The following describes the license distribution apparatus 500. The license distribution apparatus 500 is a license server that distributes a license that is obtained in advance through purchase, and the like, by the user. According to the present embodiment, the license distribution apparatus 500 distributes a license to the terminal apparatus 300. Here, a license is data which is necessary when the terminal apparatus 300 uses a content and includes a usage rule for the content and a content key. In the case where the license distribution apparatus 500 is used, the terminal apparatus 300 can use a content only when a license is included and a usage rule included in the license is satisfied.

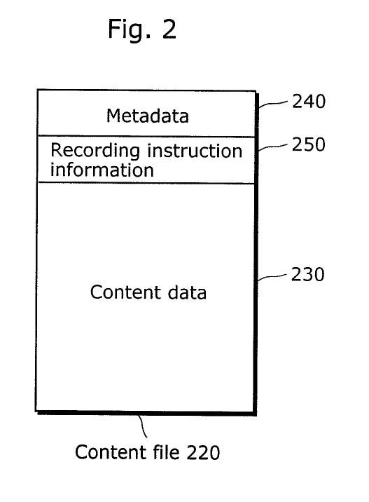

The following describes information stored in the storage unit 201 of the content distribution apparatus 200 in detail with reference to FIG. 2.

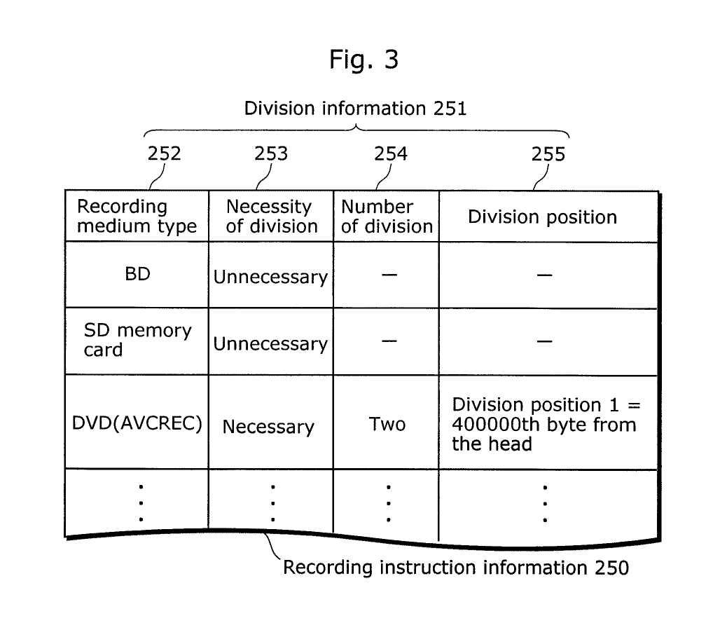

FIG. 2 is a diagram which shows an example of a content file 220 stored by the content distribution apparatus 200 according to Embodiment 1 of the present invention. The content file 220 is stored in the storage unit 201 of the content distribution apparatus 200 as shown in FIG. 2. The content file 220 is data including: content data 230 (content); metadata 240; and recording instruction information 250. The content data 230 is data of a main part of a content such as music data, image data, and the like. The metadata 240 is data that indicates information related to the content data 230 and used for identifying the content data 230 (ID: identification), a content name, and so on. The recording instruction information 250 is information which includes division information and instructs an operation of terminal apparatus 300 when recording the content data 230 on a recording medium. A detailed description on the recording instruction information 250 is given with reference to FIG. 3.

FIG. 3 is a diagram which shows an example of recording instruction information 250 stored by the content distribution apparatus 200 according to Embodiment 1 of the present invention. The recording instruction information 250 includes division information 251 as shown in FIG. 3. The division information 251 includes, for example, recording medium type 252, necessity of division 253, number of division 254, and division position 255. The recording medium type 252 is information that indicates a type and system of a recording medium on which the content data 230 is recorded. The necessity of division 253 is information that indicates whether or not the content data 230 needs to be divided when recorded on the recording medium. The number of division 254 is information that indicates on how many recording media the content data 230 is to be divided and recorded. The division position 255 is information that indicates a position at which the content data 230 is divided, and specifically, is determined by an address of the content or a time.

Here, the example of the recording instruction information 250 as shown in FIG. 3 indicates items described below.

(1) In the case where the content data 230 is recorded on a “BD” or an “SD memory card”, division of the content data 230 is “unnecessary”.

(2) In the case where the content data 230 is recorded on a “DVD” according to the “AVCREC system”, division of the content data 230 is “necessary”, the number of recording media necessary for recording the content data 230 is “two”, and the position at which the content data 230 is divided is the position of the “4000000th byte” from the head of the content data 230.

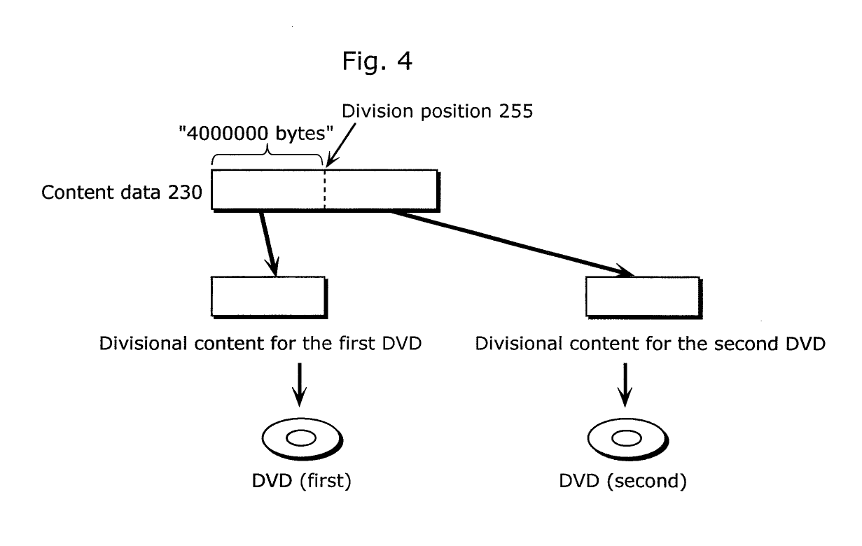

FIG. 4 shows an image of generating divisional contents in the case where the content data 230 is recorded on DVDs in the AVCREC system according to the recording instruction information 250 shown in FIG. 3.

As shown in FIG. 4, the content data 230 is divided into two contents, one is for the first DVD and the other is for the second DVD, at the position of the “4000000th byte” from the head of the content data 230. It is to be noted that, the content is divided into two pieces as an example in FIG. 4, however, the content may be divided into two or more pieces.

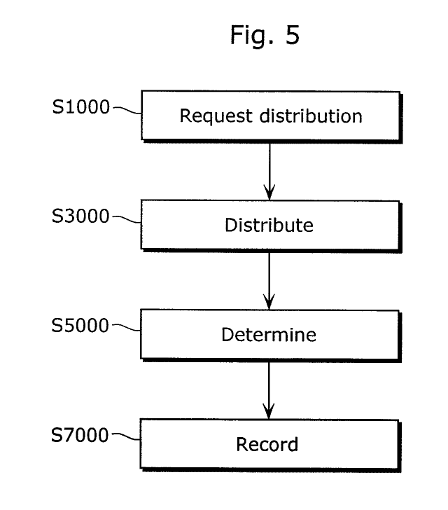

The following describes an operation of a content distribution system 100 according to Embodiment 1, configured as described above. FIG. 5 is a flow chart which shows processing of a content recording method in the content distribution system 100 according to Embodiment 1.

The content recording method according to Embodiment 1 of the present invention primarily includes: requesting distribution (S1000); distributing (S3000); determining (S5000); and recording (S7000) as shown in FIG. 5.

First, the terminal apparatus 300 requests the content distribution apparatus 200 to distribute the division information 251 (S1000). At this time, the terminal apparatus 300 simultaneously requests the content distribution apparatus 200 to distribute the content data 230. Since the division information 251 and the content data 230 are included in the content file 220, distribution of the content file 220 is requested according to the present embodiment.

Next, the content distribution apparatus 200 distributes the division information 251 and the content to the terminal apparatus 300 in response to the request from the terminal apparatus 300 for distributing the division information 251 and the content (S3000). It is to be noted that, the content file 220 including the division information 251 and the content data 230 is distributed in the present embodiment. The division information 251 and the content data 230 which have been distributed are accumulated in the content managing unit 306 of the terminal apparatus 300.

Next, the determining unit 303 of the terminal apparatus 300 compares the recording medium mounted on the terminal apparatus 300 and the division information 251 obtained from the content distribution apparatus 200 and determines whether the content data 230 is recorded on a single recording medium or divided to be recorded on plural recording media (S5000). To be specific, the determining is carried out by comparing the type of the recording medium mounted on the terminal apparatus 300 and the volume of the content data 230 based on the division information 251 such as the recording medium type 252, the necessity of division 253, the number of division 254, the division position 255, and the like.

Lastly, in the case where it is determined in the determining (S5000) that the content is to be recorded on plural recording media, the terminal apparatus 300 generates divisional contents by dividing the content into plural pieces and records the divisional contents on the plural recording media (S7000). Whereas, in the case where it is determined in the determining (S5000) that the content does not need to be divided, the terminal apparatus 300 records the content on a predetermined single recording medium without dividing the content.

The following describes further in detail operations after the above-described distributing (S3000) to the end of the above-described recording (S7000).

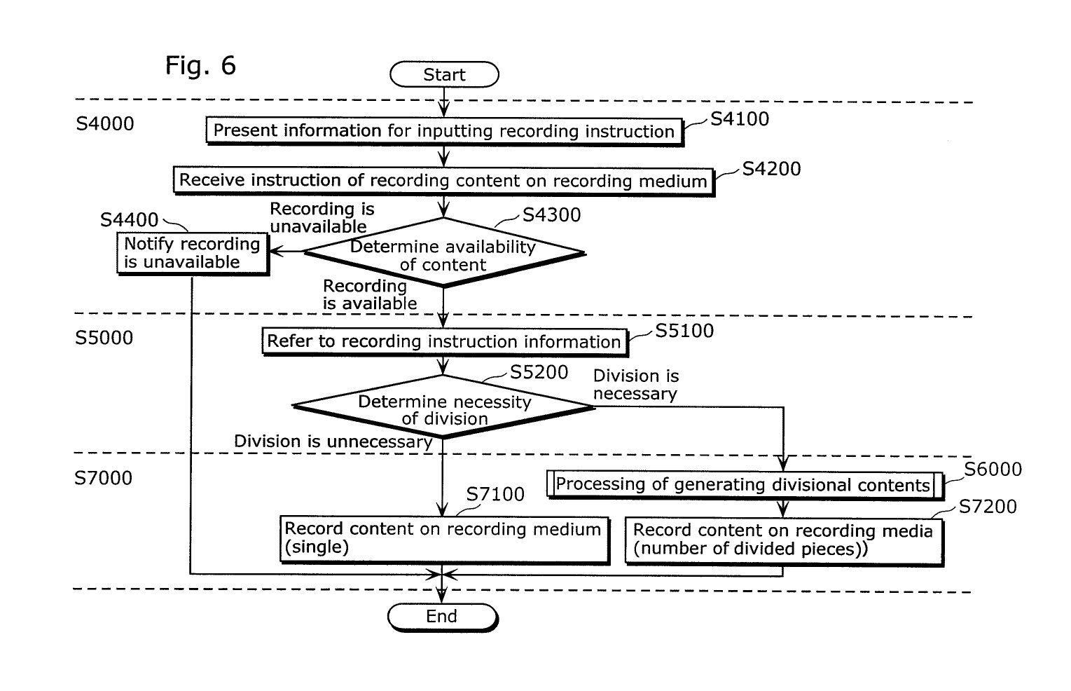

The operations between these steps include: determining recording availability (S4000); the above-described determining (S5000); generating divisional contents (S6000); and the above-described recording (S7000) as shown in FIG. 6.

First, the terminal apparatus 300, which has received the content and the division information 251 in the distributing (S3000), determines recording availability of the content, which determines whether or not the content can be recorded on the recording medium based on the license obtained from the license distribution apparatus 500 (S4000).

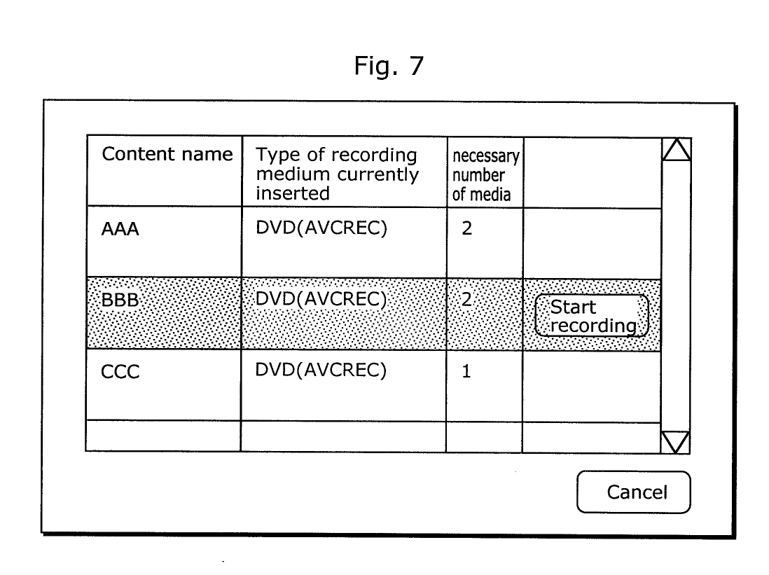

More specifically, first, information that enables instructing which content data 230 is to be recorded on which type of recording medium in which recording system is presented by using the user interaction unit 312 (S4100). FIG. 7 shows an example of information presented by the user interaction unit 312 of the terminal apparatus 300. When the user interaction unit 312 presents the information shown in FIG. 7, information related to the type and recording system of the recording medium currently inserted into the terminal apparatus 300 is obtained from the detecting unit 308 that detects the type of the recording medium, and the information is presented. Further, by referring to the metadata 240 and the recording instruction information 250 of the content file 220 managed by the content managing unit 306, a content name and information related to the number of media necessary for recording the content data 230 on the recording medium currently inserted, and the information is presented.

After that, a user gives an instruction of recording the content on the recording medium, using the information presented in Step S4100. With this, the user interaction unit 312 receives the instruction of recording the content (S4200). The instruction of recording the content includes information that indicates which content data is to be recorded on which type of recording medium in which recording system.

After that, the availability determining unit 310 determines whether or not a license corresponding to the content data 230 of which recording has been instructed is accumulated in the license managing unit 309. In the case where the license is accumulated, the availability determining unit 310 checks whether or not the usage rule included in the license is satisfied. When the check result finds that the corresponding license is accumulated in the license managing unit 309 and the usage rule included in the license is satisfied, the availability determining unit 310 determines “recording is available” (S4300). On the other hand, when the corresponding license is not accumulated in the license managing unit 309 or the usage rule included in the license is not satisfied, the availability determining unit 310 determines “recording is unavailable” and notifies the user of the terminal apparatus 300 that recording is unavailable, by using the user interaction unit 312 (S4400). In the case of “recording is unavailable”, all of the operations for recording the content is ended.

In the case where the determination results is “recording is available” in the determining recording availability (S4000), the terminal apparatus 300 determines whether to record the content on a single recording medium or to divide the content to be recorded on plural recording media (S5000).

In the determining (S5000), the terminal apparatus 300 first reads, from the content managing unit 306, and refers to the recording instruction information 250 corresponding to the content data 230 of which recording has been instructed (S5100).

Next, the terminal apparatus 300 refers to the necessity of division 253 corresponding to the recording medium type 252 specified in Step S4200 to determine whether or not it is necessary to divide the content data 230 (S5200). When the determination result finds that it is necessary to divide the content data 230, the processing proceeds to generating divisional contents (S6000). On the other hand, when the determination result finds that it is unnecessary to divide the content data 230, the determining unit 303 of the terminal apparatus 300 determines to record the content on a recording medium without division (S5200).

In the generating divisional contents (S6000), the divisional content generating unit 307 of the terminal apparatus 300 divides the content data 230 at the position specified by the division position 255 of the division information 251 to generate divisional contents.

In the recording (S7000), the recording unit 304 of the terminal apparatus 300 records the content on the recording medium. When it is determined that it is unnecessary to divide the content in the determining (S5000), the recording unit 304 records the content on a single recording medium without division (S7100). On the other hand, when it is determined that it is necessary to divide the content in the determining (S5000), the recording unit 304 sequentially records the divisional contents generated in the generating divisional contents (S6000) on plural recording media of the number of divided pieces (S7200). At this time, the user interaction unit 312 presents an instruction of changing to the next recording medium as necessary, to the user of the terminal apparatus 300.

It is to be noted that, when recording of the content or the divisional contents is ended, information indicating the completion of recording is presented to the user of the terminal apparatus 300 by using the user interaction unit 312.

As described above, with the content distribution system 100 according to the Embodiment 1 of the present invention, the content distribution apparatus 200 distributes division information 251 indicating a position at which a content is divided, to the terminal apparatus 300, and the terminal apparatus 300 divides the content according to the division position indicated by the division information 251 that has been received. According to the above configuration, in the case where a content with a large volume is to be recorded on plural recording media each of which has a small capacity, the content is divided at an appropriate position intended by a content provider.

### Embodiment 2

The following describes a content distribution system 101 according to Embodiment 2 of the present invention.

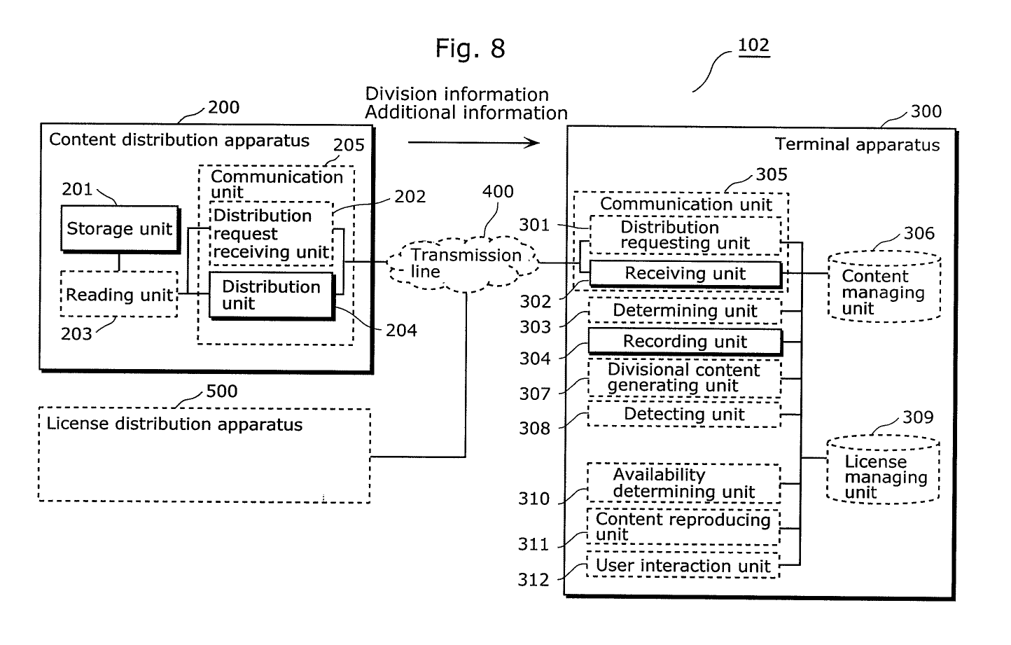

FIG. 8 is a diagram which shows an overall configuration of the content distribution system 101 according to Embodiment 2 of the present invention. It is to be noted that, the content distribution system 101 according to Embodiment 2 of the present invention has fundamentally the same configuration as that of the content distribution system 100 according to Embodiment 1 of the present invention. The content distribution system 101 according to Embodiment 2 of the present invention differs from the content distribution system 100 according to Embodiment 1 of the present invention in that additional information is distributed to the terminal apparatus in addition to division information and the additional information is added to divisional contents in the content distribution system 101 according to Embodiment 2 of the present invention.

Here, the additional information is information that is added to the main part of a content and recorded as necessary by the terminal apparatus 300 when recording the content on a recording medium, and also referred to as an additional content. An example of additional information includes credit information, a credit image, and the like. The credit information is information indicating the name of a cast, a creator, a provider, and so on of the content of a movie and the like, and also referred to as a credit title. In addition, the credit image includes a warning image called FBI Warning which related to copyright infringement and a special-feature-image such as thumbnail, menu screen, or a preview image.

The content distribution system 101 according to Embodiment 2 of the present invention is described below, focusing on the differences from the content distribution system 100 according to Embodiment 1 of the present invention. It is to be noted that description for a component with the same reference numeral as that of a component of the content distribution system 100 according to Embodiment 1 of the present invention is omitted because the function and the like is basically the same as the function and the like explained in the description of the content distribution system 100 according to Embodiment 1 of the present invention.

The content distribution system 101 according to the present embodiment has the same characteristic functional components as the content distribution system 100 according to the Embodiment 1 as shown in FIG. 8. The content distribution apparatus 200 includes: a storage unit 201; a distribution request receiving unit 202; a reading unit 203; and a distribution unit 204.

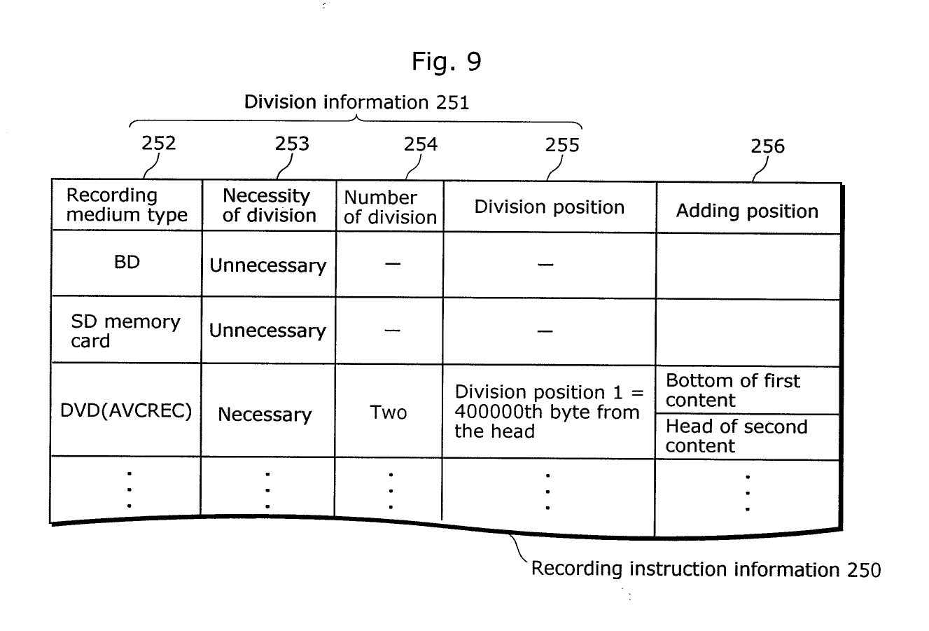

The content distribution apparatus 200 according to the Embodiment 2 of the present invention further stores additional information to be added to divisional contents, in addition to a content and division information. Further, recording instruction information 250 is stored in the storage unit 201 as with Embodiment 1, however, an additional information adding position 256 that is information to be added to divisional contents in addition to division information 251 is also stored in the storage unit 201 in Embodiment 2 as shown in FIG. 9.

The distribution request receiving unit 202 further receives a request for distributing additional information from the terminal apparatus 300 in addition to a request for distributing a content or division information. Furthermore, the distribution request receiving unit 202 receives a request for distributing the additional information adding position 256.

The reading unit 203 reads additional information from the storage unit 201, in addition to reading the division information and the content. Further, the reading unit 203 reads the additional information adding position 256 from the storage unit 201. The additional information and the additional information adding position 256 which have been read are transmitted as data to the distribution unit 204.

The distribution unit 204 distributes the additional information to the terminal apparatus 300 in addition to the division information and the content. Further, the distribution unit 204 distributes the additional information adding position 256 to the terminal apparatus 300. It is to be noted that the additional information and the additional information adding position 256 may be included in a content file together with the content and are simultaneously distributed by distributing the content file to the terminal apparatus 300.

The following describes a terminal apparatus 300 according to Embodiment 2 of the present invention. The terminal apparatus 300 according to the present embodiment includes: a distribution requesting unit 301; a receiving unit 302; a determining unit 303; and a recording unit 304, as with the terminal apparatus 300 according to Embodiment 1 of the present invention. Likewise, the terminal apparatus 300 according to the present embodiment further includes: a communication unit 305; a content managing unit 306; a divisional content generating unit 307; a detecting unit 308; a license managing unit 309; an availability determining unit 310; a content reproducing unit 311; and a user interaction unit 312.

The distribution requesting unit 301 of the terminal apparatus 300 according to Embodiment 2 of the present invention further requests the content distribution apparatus 200 for distributing the additional information in addition to the content and the division information. Furthermore, the distribution requesting unit 301 requests for distribution of the additional information adding position 256. It is to be noted that the distribution of the additional information adding position 256 may be requested for as recording instruction information 250 together with the division information 251.

Further, the receiving unit 302 receives the additional information from the content distribution apparatus 200 in addition to the content and the division information. Further, the receiving unit 302 receives the additional information adding position 256 from the content distribution apparatus 200. It is to be noted that the additional information adding position 256 may be received as the recording instruction information 250 together with the division information 251.

Further, the recording unit 304 records the additional information on the recording medium and the like at a position specified by the additional information adding position 256 in addition to the content received from the content distribution apparatus 200 or the divisional contents.

Further, the content managing unit 306 accumulates the additional information and the additional information adding position 256 which have been received by the receiving unit 302 in addition to functioning the same as the content managing unit 306 according to Embodiment 1.

Further, the divisional content generating unit 307 adds the additional information according to the additional information adding position 256 received from the content distribution apparatus 200 and generates divisional contents to which the additional information is added, in addition to functioning the same as the content managing unit 306 according to Embodiment 1.

The following describes the recording instruction information 250 stored by the content distribution apparatus 200 according to Embodiment 2 of the present invention. FIG. 9 is a diagram which shows an example of the recording instruction information 250 stored by the content distribution apparatus 200 according to Embodiment 2 of the present invention.

The recording instruction information 250 includes the division information 251 and the additional information adding position 256 as shown in FIG. 9. The recording medium type 252, the necessity of division 253, the number of division 254, and the division position 255 of the division information 251 are the same as those described in Embodiment 1 according the present invention, and thus the description is omitted.

The additional information adding position 256 as shown in FIG. 9 is information indicating a position at which the additional information is added to the divisional content.

Here, the example of the recording instruction information 250 as shown in FIG. 9 indicates items described below.

(1) In the case where the content data 230 is recorded on “BD” or “SD memory card”, division of the content data 230 is “unnecessary”.

(2) In the case where the content data 230 is recorded on a “DVD” in the “AVCREC system”, division of the content data 230 is “necessary”, the number of recording media necessary for recording the content data 230 is “two”, and the position at which the content data 230 is divided is the position of the “4000000th byte” from the head of the content data 230. To the divisional contents for the first DVD, the additional information is added at the bottom. To the divisional contents for the second DVD, the additional information is added at the head.

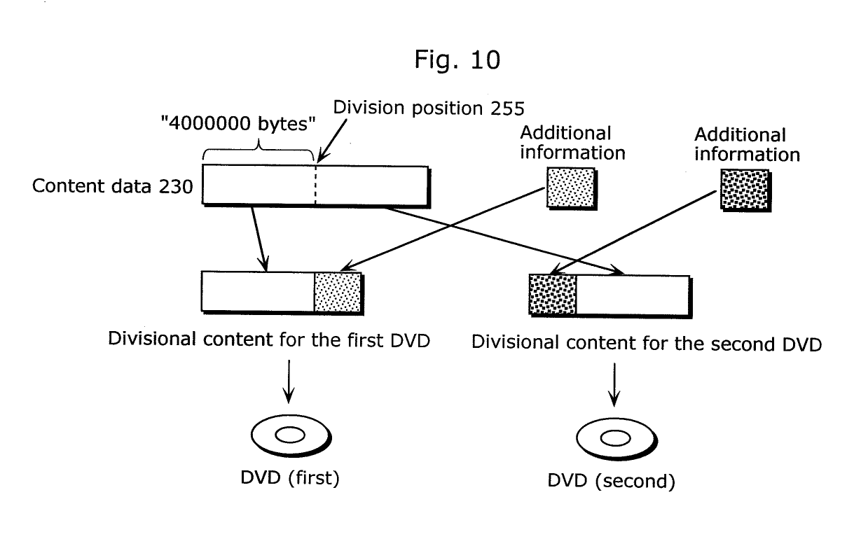

The following describes divisional contents generated by the content distribution system 101 according to Embodiment 2 of the present invention, with reference to FIG. 10. FIG. 10 is a diagram which schematically shows processing of generating divisional contents in the content distribution system 101 according to Embodiment 2 of the present invention and which shows an image of generating divisional contents in the case where the content data 230 is recorded on DVDs in the AVCREC system according to the recording instruction information 250 shown in FIG. 9.

As shown in FIG. 10, the content data 230 is divided into two contents, one is for the first DVD and the other is for the second DVD, at the position of the “4000000th byte” from the head of the content data 230. Then, the additional information distributed from the content distribution apparatus 200 is added to the divisional contents according to the additional information adding position 256. It is to be noted that the content is divided into two pieces and the additional information is added at the bottom of the divisional content for the first DVD and at the head of the divisional content for the second DVD in FIG. 10, however, the position at which the additional information is added is not limited to this. For example, the additional information may be added at the head of the divisional content for the first DVD and at the bottom of the divisional content for the second DVD. Further, the additional information may be added at the head or at the bottom, for both of the divisional contents.

Further, the content of the additional information added to each of the two divisional contents may be the same as or different from each other. The content of the additional information may be determined arbitrarily according to the intention of a content creator.

The following describes an operation of the content distribution system 101 according to Embodiment 2, configured as described above. It is to be noted that the operation of the content distribution system 101 according to Embodiment 2 of the present invention is fundamentally the same as that described in the flow chart showing processing of the content recording method as shown in FIG. 5 and FIG. 6, which is explained in the description for the content distribution system 100 according to Embodiment 1. Thus, the operation of the content distribution system 101 according to Embodiment 2 is described below, focusing on the differences from the operation of the content distribution system 100 according to Embodiment 1.

According to the present embodiment, the terminal apparatus 300 requests the content distribution apparatus 200 for distributing the additional information and the additional information adding position 256 in the requesting distribution, as shown in FIG. 5 (S1000).

Further, in the distributing (S3000), the content distribution apparatus 200 distributes the additional information and the additional information adding position 256 to the terminal apparatus 300 in addition to distributing the division information 251. The distributed additional information and the additional information adding position 256 are accumulated in the content managing unit 306. It is to be noted that, in the present embodiment, since the additional information and the additional information adding position are included in the content file together with the content or the division information, the data or information is simultaneously distributed to the terminal apparatus by distributing the content file.

Further, in the generating divisional contents (S6000), divide contents to which the additional information is added at the position specified by the adding position 256 are also generated. The additional information is added by the divisional content generating unit 307 of the terminal apparatus 300.

In the recording (S7000), in the case where it is determined in the determining (S5000) that the content is to be recorded on plural recording media, divisional contents to which the additional information is added are recorded on plural recording media.

It is to be noted that the additional information is obtained at the same time as the division information in the present embodiment, however, the timing of obtaining the additional information is not limited to this, and can be arbitrarily selected.

As described above, according the content distribution system 101 according to Embodiment 2 of the present invention, additional information is further added to divisional contents, when compared to the content distribution system 100 according to Embodiment 1. This allows a content provider to divide a content at an intended position while adding intended additional information to divisional contents. For example, the content provider can insert additional information such as a preview image of a movie at an intended position of divisional contents. Further, addition of the additional information allows a user of a content to maintain the relation between divisional contents and to handle the content easily by using the additional information such as added thumbnail even when the content is divided.

### Embodiment 3

The following describes a content distribution system 102 according to Embodiment 3 of the present invention.

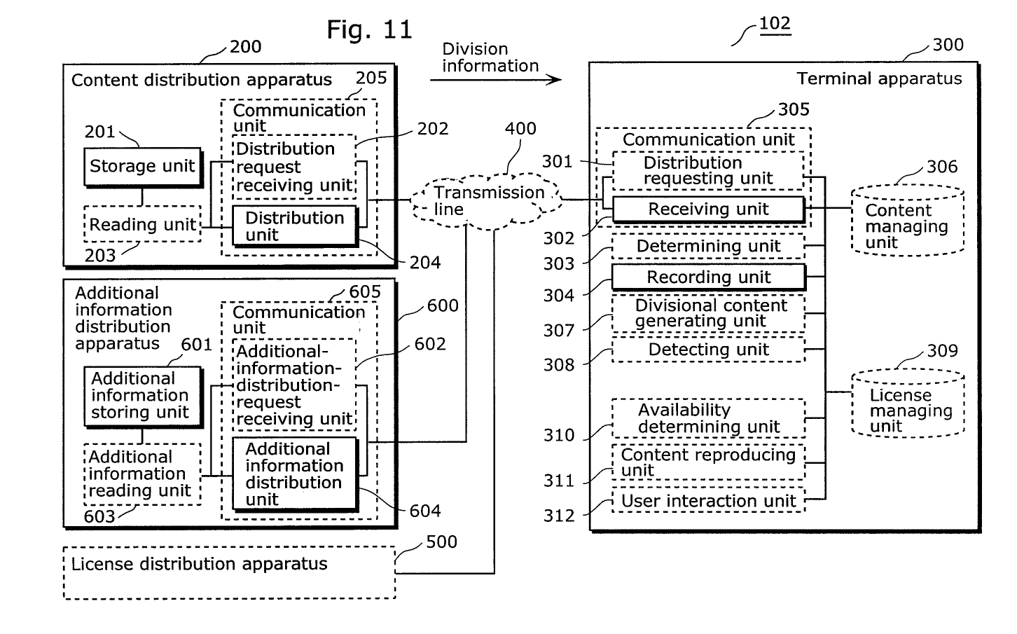

FIG. 11 is a diagram which shows an overall configuration of the content distribution system 102 according to Embodiment 3 of the present invention. It is to be noted that, the content distribution system 102 according to Embodiment 3 of the present invention has fundamentally the same configuration as that of the content distribution system 101 according to Embodiment 2 of the present invention. The content distribution system 102 according to Embodiment 3 of the present invention differs from the content distribution system 101 according to Embodiment 2 of the present invention in that additional information is distributed from an additional information distribution apparatus in the content distribution system 102 according to Embodiment 3 of the present invention.

The content distribution system 102 according to Embodiment 3 of the present invention is described below focusing on components different from those in the content distribution systems 100 and 102 according to Embodiments 1 and 2 of the present invention, and description for components having the same reference numerals and no particular explanation is omitted because the function and the like is the same as the function and the like explained for components in the content distribution systems 100 and 101 according to Embodiments 1 and 2 of the present invention.

The content distribution system 102 according to the present embodiment has the same characteristic functional components as the content distribution systems 100 and 101 according to the Embodiments 1 and 2, as shown in FIG. 11. The content distribution system 102 includes: a content distribution apparatus 200; a terminal apparatus 300; a transmission line 400; and a license distribution apparatus 500. Further, the content distribution system 102 according to the present embodiment includes an additional information distribution apparatus 600. It is to be noted that the content distribution apparatus 200 and the additional information distribution apparatus 600 are also called as the first server and the second server, respectively, according to the present embodiment.

The content distribution apparatus 200 according to Embodiment 3 of the present invention includes: a storage unit 201; a distribution request receiving unit 202; a reading unit 203; and distribution unit 204, as with the content distribution apparatus 200 according to Embodiments 1 and 2.

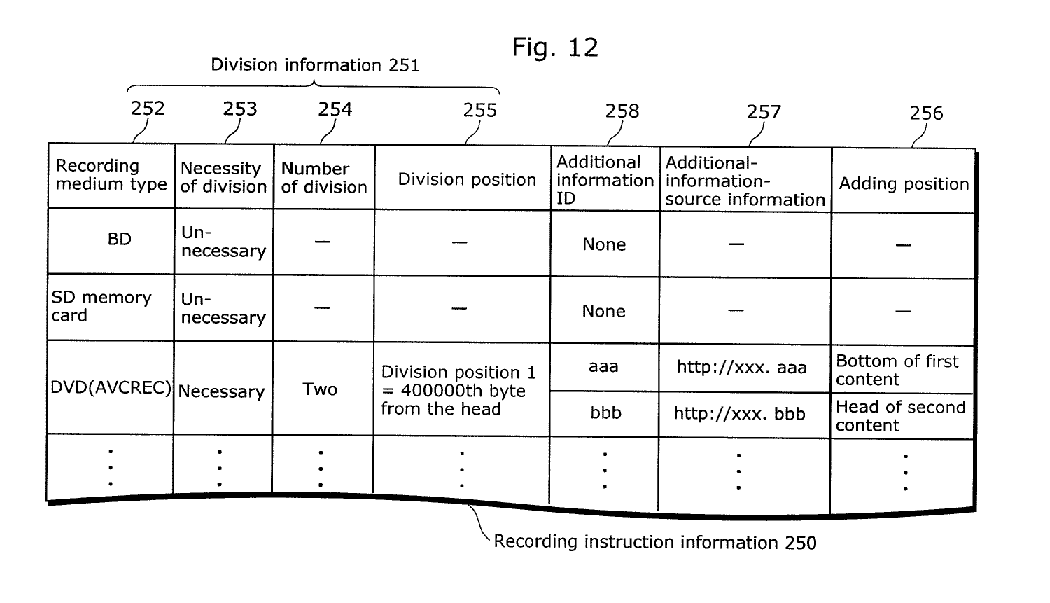

The content distribution apparatus 200 according to Embodiment 3 of the present invention further stores additional-information-source information that indicates the source from which additional information is obtained and an additional information ID (additional information identifier) that is necessary for obtaining the additional information, in addition to those stored in the storage unit 201 of Embodiment 2. It is to be noted that the storage unit 201 stores the recording instruction information 250 as in Embodiments 1 and 2, and additional-information-source information 257 and additional information ID 258 are included in the recording instruction information 250 as shown in FIG. 12. In the present embodiment, the additional information is stored in the additional information distribution apparatus 600 described below, the additional information distribution apparatus 600 and the additional information are specified by the additional-information-source information 257 and the additional information ID 258, and the additional information that has been specified is distributed from the additional information distribution apparatus 600 to the terminal apparatus 300.

Further, the distribution request receiving unit 202 receives, from the terminal apparatus 300, a request for distributing the additional-information-source information 257 and the additional information ID 258, in addition to those received by the distribution request receiving unit 202 the distribution request receiving unit 202 of the Embodiment 2.

Further, the reading unit 203 reads, from the storage unit 201, the additional-information-source information 257 and the additional information ID 258, in addition to those read by the distribution request receiving unit 202 of the Embodiment 2. The additional-information-source information 257 and the additional information ID 258 which have been read are transmitted as data to the distribution unit 204.

Furthermore, the distribution unit 204 further distributes the additional-information-source information 257 and the additional information ID 258 to the terminal apparatus 300.

The following describes the terminal apparatus 300 according to Embodiment 3 of the present invention. The terminal apparatus 300 according to the present embodiment includes: a distribution requesting unit 301; a receiving unit 302; a determining unit 303; and a recording unit 304, as with the terminal apparatus 300 according to Embodiment 2 of the present invention. Likewise, the terminal apparatus 300 according to the present embodiment further includes: a communication unit 305; a content managing unit 306; a divisional content generating unit 307; a detecting unit 308; a license managing unit 309; an availability determining unit 310; a content reproducing unit 311; and a user interaction unit 312.

The distribution requesting unit 301 of the terminal apparatus 300 according to Embodiment 3 of the present invention requests the content distribution apparatus 200 for distributing the additional-information-source information 257, in addition to the content and the division information. Further, the distribution requesting unit 301 requests the additional information distribution apparatus 600 for distributing the additional information based on the additional-information-source information 257 obtained from the content distribution apparatus 200. Further, the distribution requesting unit 301 may simultaneously request the content distribution apparatus 200 for distributing the additional information ID 258 when requesting distribution of the additional-information-source information 257.

Further, the receiving unit 302 further receives the additional-information-source information 257 and the additional information ID 258, in addition to the division information and the content, from the content distribution apparatus 200. Further, the receiving unit 302 receives, from the additional information distribution apparatus 600 specified by the additional-information-source information 257, the additional information specified by the additional information ID 258. It is to be noted that the additional-information-source information 257 and the additional information ID 258 are received together with the division information 251, as the recording instruction information 250, according to the present embodiment.

It is to be noted that the recording unit 304 records the additional information on the recording medium by adding the additional information at the position specified by the additional information adding position 256, in addition to recording the divisional content on the recording medium and the like as in Embodiment 2.

Further, the content managing unit 306 accumulates the additional-information-source information 257 and the additional information ID 258 received by the receiving unit 302.

It is to be noted that the divisional content generating unit 307 generates divisional contents to which the additional information is added, by adding the additional information according to the additional information adding position 256 obtained from the content distribution apparatus 200.

The following describes the additional information distribution apparatus 600 according to Embodiment 3 of the present invention.

As shown in FIG. 11, the additional information distribution apparatus 600 according to the present embodiment is, for example, a content server, and an apparatus which manages additional information to be added to divisional contents and distributes the additional information to the terminal apparatus 300 according to a request from the terminal apparatus 300.

The additional information distribution apparatus 600 according to Embodiment 3 of the present invention includes: an additional information storing unit 601; an additional-information-distribution-request receiving unit 602; an additional information reading unit 603; and an additional information distribution unit 604, as shown in FIG. 11.

The additional information storing unit 601 stores the additional information.

The additional-information-distribution-request receiving unit 602 receives a request for distributing the additional information from the terminal apparatus 300. At this time, the additional-information-distribution-request receiving unit 602 may simultaneously receive the additional information ID from the terminal apparatus 300.

The additional information reading unit 603 reads the additional information from the additional information storing unit 601 according to the additional information ID 258 in response to the distribution request received by the additional-information-distribution-request receiving unit 602.

It is to be noted that the communication unit 605, which includes the additional-information-distribution-request receiving unit 602 and the additional information distribution unit 604, is a communication interface that communicates with the terminal apparatus 300 via the transmission line 400.

The following describes the recording instruction information 250 stored by the content distribution apparatus 200 according to Embodiment 3 of the present invention. FIG. 12 is a diagram which shows an example of the recording instruction information 250 stored by the content distribution apparatus 200 according to Embodiment 3 of the present invention.

The recording instruction information 250, which is included in a content file together with content data, includes the division information 251, the additional information adding position 256, the additional-information-source information 257, and the additional information ID 258, as shown in FIG. 12. The recording medium type 252, the necessity of division 253, the number of division 254, the division position 255, and the additional information adding position 256 of the division information 251 are the same as those described in Embodiment 2, and thus the description is omitted.

The additional-information-source information 257 shown in FIG. 12, which is information that specifies the source from which the additional information (additional content) is obtained, is information such as a uniform resource locator (URL) of the additional information distribution apparatus 600, an e-mail address, a telephone number, and so on. Further, the additional information ID 258, which is an identifier (ID) of the additional information, is individually associated with additional information. The additional information ID individually specifies additional information stored in the additional information distribution apparatus 600, so that additional information to be added to divisional contents is specified as described below.

Here, the example of the recording instruction information 250 as shown in FIG. 12 indicates items described below.

(1) In the case where the content data 230 is recorded on “BD” or “SD memory card”, division of the content data 230 is “unnecessary”.

(2) In the case where the content data 230 is recorded on a “DVD” in the “AVCREC system”, division of the content data 230 is “necessary”, the number of recording media necessary for recording the content data 230 is “two”, and the position at which the content data 230 is divided is the position of the “4000000th byte” from the head of the content data 230. When recording the content data 230, two pieces of additional information are recorded, one of which has “aaa” and the other has “bbb” as the additional information ID 258. The additional information having “aaa” as the additional information ID 258 is obtained from the additional information distribution apparatus 600 whose URL is “http://xxx.aaa”. The additional information having “bbb” as the additional information ID 258 is obtained from the additional information distribution apparatus 600 whose URL is “http://xxx.bbb”. The additional information having “aaa” as the additional information ID 258 is recorded at the bottom of the first divisional content. The additional information having “bbb” as the additional information ID 258 is recorded at the head of the second divisional content.

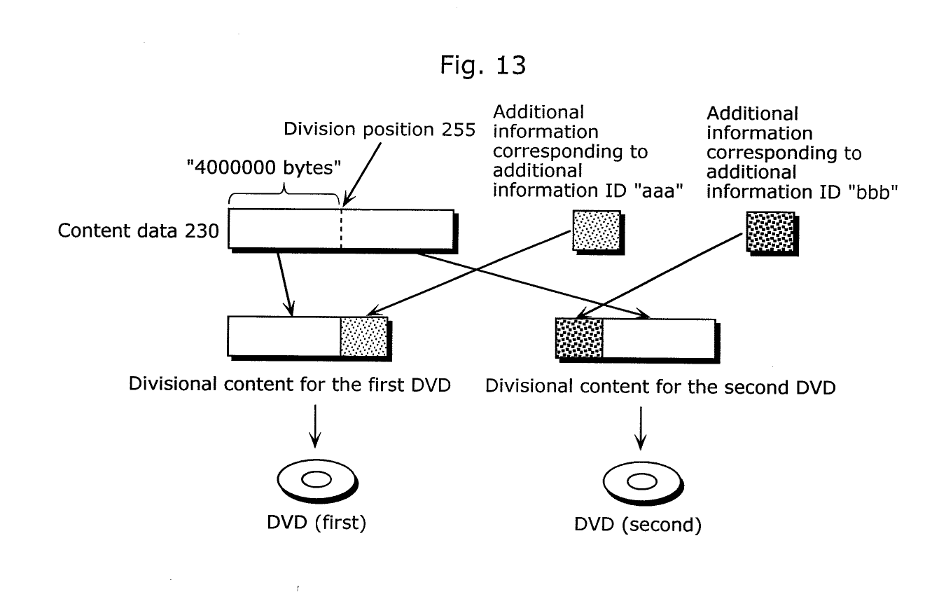

The following describes divisional contents generated by the content distribution system 102 according to Embodiment 3 of the present invention, with reference to FIG. 13. FIG. 13 is a diagram which schematically shows processing of generating divisional contents in the content distribution system 102 according to Embodiment 3 of the present invention and which shows an image of generating divisional contents in the case where the content data 230 is recorded on DVDs in the AVCREC system according to the recording instruction information 250 shown in FIG. 12.

As shown in FIG. 13, the content data 230 is divided into two contents, one is for the first DVD and the other is for the second DVD, at the position of the “4000000th byte” from the head of the content data 230. The additional information corresponding to “aaa” as the additional information ID is added at the bottom of the divisional content for the first DVD and the additional information corresponding to “bbb” as the additional information ID is added at the head of the divide content for the second DVD.

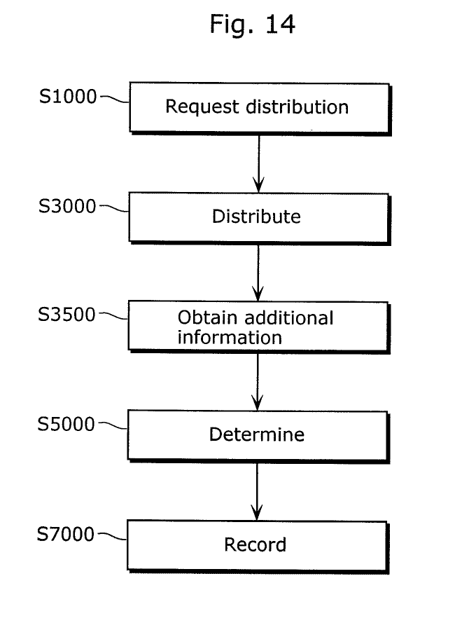

The following describes an operation of the content distribution system 102 according to Embodiment 3, configured as described above, with reference to FIG. 14. FIG. 14 is a flow chart which shows processing of a content recording method in the content distribution system 102 according to Embodiment 3.

It is to be noted that, the description for the operations (steps) having the same reference numerals as those described for the content distribution systems 100 and 101 according to Embodiments 1 and 2 shown in FIG. 5 and FIG. 6 is omitted and the description is given focusing on different operations.

As shown in FIG. 14, the content recording method according to Embodiment 3 includes: requesting distribution (S1000); distributing (S3000); obtaining additional information (S3500); determining (S5000); and recording (S7000). The obtaining additional information (S3500) is a step not included in Embodiments 1 and 2.

First, as with Embodiment 1 of the present invention, the terminal apparatus 300 requests the content distribution apparatus 200 for distributing the division information 251 and so on (S1000).

In the present embodiment, the terminal apparatus 300 further requests the content distribution apparatus 200 for distributing the additional information adding position 256, the additional-information-source information 257, and the additional information ID 258 (S1000).

Next, the content distribution apparatus 200 distributes the terminal apparatus 300 the division information 251 together with the additional information adding position 256, the additional-information-source information 257, and the additional information ID 258, in response to the request for distributing the division information from the terminal apparatus 300 (S3000).

Next, the terminal apparatus 300 obtains, from the additional information distribution apparatus 600 specified by the additional-information-source information 257, additional information specified by the additional information ID, by using the additional-information-source information 257 and the additional information ID 258 obtained from the content distribution apparatus 200 (S3500).

Next, the determining unit 303 of the terminal apparatus 300 compares the recording medium mounted on the terminal apparatus 300 and the division information 251 obtained from the content distribution apparatus 200, and determines whether the content data 230 is to be recorded on a single recording medium or divided to be recorded on plural recording media (S5000). This step is the same as that in Embodiment 2, and thus the detailed explanation is omitted.

Lastly, in the case where it is determined in the determining (S5000) that the content is to be recorded on plural recording media, the terminal apparatus 300 generates divisional contents by dividing the content into plural pieces and records the divisional contents on the plural recording media (S7000). Whereas, in the case where it is determined in the determining (S5000) that the content does not need to be divided, the terminal apparatus 300 records the content on a predetermined single recording medium without dividing the content.

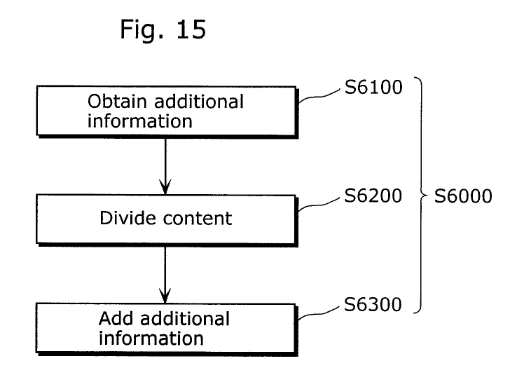

It is to be noted that the obtaining additional information (S3500) is performed between the distributing (S3000) and the determining (S5000) in the present embodiment, however, the obtaining additional information (S3500) may be performed in the generating divisional contents (S6000) shown in FIG. 6. More specifically, as shown in FIG. 15, for example, the terminal apparatus 300 first refers to the additional-information-source information 257 and the additional information ID 258 obtained from the content distribution apparatus 200 and obtains, from the additional information distribution apparatus 600 specified by the additional-information-source information 257, additional information corresponding to the ID specified by the additional information ID 258 (S6100). Next, the divisional content generating unit 307 of the terminal apparatus 300 divides the content data 230 at a position specified by the division position 255 (S6200). Then, the divisional content generating unit 307 adds the obtained additional information at the position specified by the division position 255 (S6300). It is to be noted that the timing of obtaining the additional information is not limited to this, and may be arbitrarily selected.

As described above, the content distribution system 102 according to Embodiment 3 of the present invention produces the advantageous effect same as the advantageous effect of the content distribution systems 100 and 101 according to Embodiments 1 and 2. Further, unlike the Embodiment 2, additional information is obtained from the second server that is different from the first server that distributes a content, according to the present embodiment. With this, the second server can distribute additional information of a content when necessary, making it possible to eliminate the load of distributing the additional information from the first server. Further, since a content and additional information can be managed by different servers, a provider of the additional information (additional content) can have an increased flexibility in generating, modifying, and distributing the additional information.

It is to be noted that the additional information distribution apparatus 600 in the content distribution system 102 according to Embodiment 3 is explained as a single apparatus (server), however, plural additional information distribution apparatuses may be employed.

The present invention has been described based on the above-described three embodiments, however, the present invention is not limited to the above-described embodiments.

For example, divisional contents are generated by the terminal apparatus 300 according to the above-described three embodiments, however, divisional contents may be generated by the content distribution apparatus 200. In this case, the terminal apparatus 300 transmits information regarding the type of a recording medium to the content distribution apparatus 200 after obtaining division information from the content distribution apparatus 200. The content distribution apparatus 200 arbitrarily divides a content based on the information on the type of the recording medium and the volume of content data. Then, the divisional contents are distributed to the terminal apparatus 300.

In addition, divisional contents are recorded on the recording medium that is removably mounted directly on the terminal apparatus according to the above-described three embodiments, however, the recording medium does not necessarily have to be mounted directly on the terminal apparatus. However, divisional contents are recorded on the recording medium by the terminal apparatus 300 still in this case.

Further, the following cases are included as implementations of the present invention.

(1) Each of the aforementioned apparatuses is, specifically, a computer system including a microprocessor, a ROM, a RAM, a hard disk unit, a display unit, a keyboard, a mouse, and so on. A computer program is stored in the RAM or hard disk unit. The respective apparatuses achieve their functions through the microprocessor's operation according to the computer program. Here, the computer program is configured by combining plural instruction codes indicating instructions for the computer in order to achieve predetermined functions.

(2) A part or all of the constituent elements constituting the respective apparatuses may be configured from a single System-LSI (Large-Scale Integration). The System-LSI is a super-multi-function LSI manufactured by integrating constituent units on one chip, and is specifically a computer system configured by including a microprocessor, a ROM, a RAM, and so on. A computer program is stored in the RAM. The System-LSI achieves its function through the microprocessor's operation according to the computer program.

(3) A part or all of the constituent elements constituting the respective apparatuses may be configured as an IC card which can be attached and detached from the respective apparatuses or as a stand-alone module. The IC card or the module is a computer system configured from a microprocessor, a ROM, a RAM, and so on. The IC card or the module may also include the aforementioned super-multi-function LSI. The IC card or the module achieves its function through the microprocessor's operation according to the computer program. The IC card or the module may also be implemented to be tamper-resistant.

(4) The present invention may be a computer program for realizing, using a computer, the content recording method described in each of the above-described embodiments. Further, the present invention may also be a digital signal including the computer program.

Furthermore, the present invention may also be realized by storing the computer program or the digital signal in a computer readable recording medium. The recording medium includes a magnetic disk, an optical disk, a magnet-optical disk, an IC card, and a semiconductor memory, such as flexible disc, a hard disk, a CD-ROM, an MO, a DVD, a DVD-ROM, a DVD-RAM, a BD (Blu-ray Disc). Furthermore, the present invention may also include the digital signal recorded in these recording media.

Furthermore, the present invention may also be realized by the transmission of the aforementioned computer program or digital signal via a telecommunication line, a wireless or wired communication line, a network represented by the Internet, a data broadcast and so on.

The present invention may also be a computer system including a microprocessor and a memory, in which the memory stores the aforementioned computer program and the microprocessor operates according to the computer program.

Furthermore, by transferring the program or the digital signal by recording onto the aforementioned recording media, or by transferring the program or digital signal via the aforementioned network and the like, execution using another independent computer system is also made possible.

(5) Each of the embodiments described above may be applied to each of the modifications.

### INDUSTRIAL APPLICABILITY

The content distribution system, the content recording method and apparatus, and the like according to the present invention are useful in a system that performs content distribution services using a digital broadcasting, CATV, the Internet, and so on, and in an apparatus and the like included in the system.

### REFERENCE SIGNS LIST

100, 101, 102, content distribution system
200 content distribution apparatus
201 storage unit
202 distribution request receiving unit
203 reading unit
204 distribution unit
205, 305, 605, communication unit
220 content file
230 content data
240 metadata
250 recording instruction information
251 division information
252 recording medium type
253 necessity of division
254 number of division
255 division position
256 additional information adding position
257 additional-information-source information
258 additional information ID
300 terminal apparatus
301 distribution requesting unit
302 receiving unit
303 determining unit
304 recording unit
306 content managing unit
307 divisional content generating unit
308 detecting unit
309 license managing unit
310 availability determining unit
311 content reproducing unit
312 user interaction unit
400 transmission line
500 license distribution apparatus
600 additional information distribution apparatus
601 additional information storing unit
602 additional-information-distribution-request receiving unit
603 additional information reading unit
604 additional information distribution unit

1. A content distribution system comprising:
a content distribution apparatus configured to distribute a content; and
a terminal apparatus configured to record the content,
wherein said content distribution apparatus includes:
a storage unit configured to store division information indicating a division position at which the content is divided according to a type of at least one of recording media; and
a distribution unit configured to distribute, to said terminal apparatus, the division information read from said storage unit, and
said terminal apparatus includes:
a receiving unit configured to receive the division information from said content distribution apparatus; and
a recording unit configured to record each of divisional contents on a corresponding one of the recording media, the divisional contents being generated by dividing the content at the division position indicated by the division information.

2. The content distribution system according to claim 1,
wherein, in said content distribution apparatus,
said storage unit is further configured to store additional information to be added to the divisional contents, and
said distribution unit is further configured to distribute, to said terminal apparatus, the additional information read from said storage unit, and
in said terminal apparatus,
said receiving unit is further configured to receive the additional information from said content distribution apparatus, and
said recording unit is further configured to record the additional information together with each of the divisional contents on a corresponding one of the recording media.

3. The content distribution system according to claim 1,
further comprising an additional information distribution apparatus configured to manage additional information to be added to the divisional contents,
wherein said additional information distribution apparatus includes:
an additional information storing unit configured to store the additional information; and
an additional information distribution unit configured to distribute, to said terminal apparatus, the additional information read from said additional information storing unit,
in said content distribution apparatus,
said storage unit is further configured to store additional-information-source information indicating a source from which the additional information is obtained, and
said distribution unit is further configured to distribute the additional-information-source information to said terminal apparatus, and
in said terminal apparatus,
said receiving unit is further configured to receive the additional-information-source information from said content distribution apparatus and to receive the additional information from said additional information distribution apparatus based on the additional-information-source information, and
said recording unit is further configured to record the additional information together with each of the divisional contents on a corresponding one of the recording media.

4. The content distribution system according to claim 2,
wherein said recording unit is configured to add the additional information before or after each of the divisional contents.

5. The content distribution system according to claim 1,
wherein said terminal apparatus includes a divisional content generating unit configured to generate the divisional contents by dividing the content.

6. The content distribution system according to claim 1,
wherein the recording media are removably mounted on said terminal apparatus.

7. A terminal apparatus which obtains a content and records the content on at least one of recording media, said terminal apparatus comprising:
a receiving unit configured to receive division information from a content distribution apparatus that stores the division information indicating a position at which the content is divided according to a type of the recording media; and
a recording unit configured to record each of divisional contents on a corresponding one of the recording media, the divisional contents being generated by dividing the content at the division position indicated by the division information.

8. The terminal apparatus according to claim 7,
wherein the content distribution apparatus further stores additional information to be added to the divisional contents,
said receiving unit is further configured to receive the additional information from the content distribution apparatus, and
said recording unit is further configured to record the additional information together with each of the divisional contents on the corresponding one of the recording media.

9. The terminal apparatus according to claim 7,
connected to an additional information distribution apparatus that manages the additional information to be added to the divisional contents,
wherein the content distribution apparatus further stores additional-information-source information indicating a source from which the additional information is obtained,
in said terminal apparatus,
said receiving unit is further configured to receive the additional-information-source information from the content distribution apparatus and to receive the additional information from the additional information distribution apparatus based on the additional-information-source information, and
said recording unit is further configured to record the additional information together with each of the divisional contents on the corresponding one of the recording media.

10. The terminal apparatus according to claim 8,
wherein said recording unit is configured to add the additional information before or after each of the divisional contents.

11. The terminal apparatus according to claim 7,
further comprising a divisional content generating unit configured to generate the divisional contents by dividing the content.

12. The terminal apparatus according to claim 7,
wherein the recording media are removably mounted on said terminal apparatus.

13. The terminal apparatus according to claim 7, further comprising:
a detecting unit configured to detect a type of the recording media; and
a determining unit configured to determine, based on the division information and the type of each of the recording media detected by said detecting unit, whether the content is to be recorded on a single recording medium among the recording media or to be divided and recorded on the recording media.

14. The terminal apparatus according to claim 13,
wherein said determining unit is configured to record the content on the recording medium without dividing the content in the case where it is determined that the content need not be divided.

15. A content distribution apparatus which distributes a content to a terminal apparatus that records divisional contents on recording media, said content distribution apparatus comprising:
a storage unit configured to store division information indicating a division position at which the content is divided according to a type of the recording media; and
a distribution unit configured to distribute, to the terminal apparatus, the division information read from said storage unit.

16. The content distribution apparatus according to claim 15,
wherein said storage unit is further configured to store additional information to be added to the content divided based on the division information, and
said distribution unit is further configured to distribute, to the terminal apparatus, the additional information read from said storage unit.

17. An additional information distribution apparatus which distributes, to a terminal apparatus that divides and records a content on recording media, additional information to be added to divisional content,
said additional information distribution apparatus being connected to a content distribution apparatus that distributes, to the terminal apparatus, division information indicating a position at which the content is divided according to a type of the recording media and additional-information-source information indicating a source from which the additional information is obtained,
said additional information distribution apparatus comprising:
an additional information storing unit configured to store the additional information; and
an additional information distribution unit configured to distribute, to the terminal apparatus, the additional information read from said additional information storing unit.

18. A content recording method for recording a content distributed from a content distribution apparatus by using a terminal apparatus, said method comprising:
distributing division information from the content distribution apparatus to the terminal apparatus, the division information indicating a division position at which the content is divided according to a type of at least one of recording media; and
recording each of divisional contents on a corresponding one of recording media, the divisional contents being generated by dividing the content at the division position indicated by the division information.

19. The content recording method according to claim 18,
further comprising obtaining additional information to be added the divisional contents,
wherein said recording includes recording the additional information together with each of the divisional contents on the corresponding one of the recording media.

20. A computer-readable recording medium on which a program for recording, using a terminal apparatus, a content distributed from a content distribution apparatus is stored, the program allowing a computer to execute:
distributing division information from the content distribution apparatus to the terminal apparatus, the division information indicating a division position at which the content is divided according to a type of at least one of recording media; and
recording each of divisional contents on a corresponding one of recording media, the divisional contents being generated by dividing the content at the division position indicated by the division information.

21. The computer-readable recording medium according to claim 20,
wherein the program further causes a computer to execute: obtaining additional information to be added to the divisional contents, and
said recording includes recording the additional information together with each of the divisional contents on the corresponding one of the recording media.
